(19) United States
(12) Patent Application Publication
(10) Pub. No.: US 2025/0106319 A1
(43) Pub. Date: Mar. 27, 2025

(54) SYSTEMS AND METHODS FOR SHARED ELECTRONIC DEVICE OPERATION

(71) Applicant: Apple Inc., Cupertino, CA (US)

(72) Inventor: Libo Cao Meyers, San Jose, CA (US)

(21) Appl. No.: 18/889,138

(22) Filed: Sep. 18, 2024

Related U.S. Application Data
(60) Provisional application No. 63/540,815, filed on Sep. 27, 2023.

(51) Int. Cl. H04M 1/72484

(52) U.S. Cl. CPC H04M 1/72484

(57) ABSTRACT

Systems and methods described herein provide shared electronic device operation. In one example, a shared operation configuration for a plurality of users of an electronic device is obtained. A device trigger corresponding to operation of the electronic device is detected. A particular user is identified amongst the plurality of users based on the shared operation configuration. A user device associated with the particular user is identified. An operation alert representing the device trigger is generated, wherein the operation alert is sent to the user device.

### CROSS-REFERENCE TO RELATED APPLICATIONS

The present application claims priority to U.S. Provisional Application No. 63/540,815, filed Sep. 27, 2023, which is incorporated by reference in its entirety herein.

### FIELD

Aspects of the present disclosure relate to systems and methods for shared electronic device operation and more particularly to alert routing in connection with shared operation of an electronic device.

### BACKGROUND

Electronic devices perform a variety of operations. There may be various scenarios in which operation of an electronic device is shared among a plurality of users. However, responding to operational issues of the electronic device is challenging when operation is shared.

### SUMMARY

Implementations described and claimed herein provide systems and methods for shared electronic device operation. In some implementations, a shared operation configuration for a plurality of users of an electronic device is obtained. A device trigger corresponding to operation of the electronic device is detected. A particular user is identified amongst the plurality of users based on the shared operation configuration. A user device associated with the particular user is identified. An operation alert representing the device trigger is generated, wherein the operation alert is sent to the user device.

In some implementations, a device trigger corresponding to an electronic device is detected. Operation of the electronic device is shared among a plurality of users. A particular user of the plurality of users is identified. A user device is associated with the particular user. An operation alert is generated based on the device trigger. The operation alert is sent to the user device.

In some implementations, at least one processor configured to generate an operation alert and identify a particular user of a plurality of users. The operation alert is generated based on a device trigger corresponding to an electronic device. Operation of the electronic device is shared among the plurality of users, wherein the operation alert is provided to a user device associated with the particular user.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example environment for shared electronic device operation.

FIG. 2 illustrates generation of an example operation alert.

FIG. 3 illustrates example operations for generating a shared operation configuration.

FIG. 4 illustrates example operations for shared electronic device operation.

FIG. 5 shows an example electronic device.

FIG. 6 shows an example computing system that may implement various aspects of the presently disclosed technology.

### DETAILED DESCRIPTION

Aspects of the presently disclosed technology relate to systems and methods for shared electronic device operation. In various scenarios, an electronic device may be shared amongst a plurality of users. For example, the plurality of users may each have access to operate the electronic device during respective operation sessions. In another example, one user may operate the electronic device while another user monitors the operation according to user preferences (e.g., a parent supervising operation by a child). The electronic device may experience an operational issue. However, with such shared operation of the electronic device amongst the plurality of users, detecting the operational issue and identifying and alerting the appropriate user(s) is challenging. Accordingly, in some aspects, a device trigger corresponding to the electronic device is detected. A particular user of the plurality of users is identified, and a user device is associated with the particular user. An operation alert is generated based on the device trigger, and the operation alert is sent to the user device. Other users and/or user devices may also receive the operation alert. The particular users and particular user devices that receive a given operation alert representing a device trigger may be customized using a shared operation configuration. In this manner, appropriate parties may be timely alerted to operational issues for response. Additionally or alternatively, the electronic device may be used in different manners depending on a particular user's preferences.

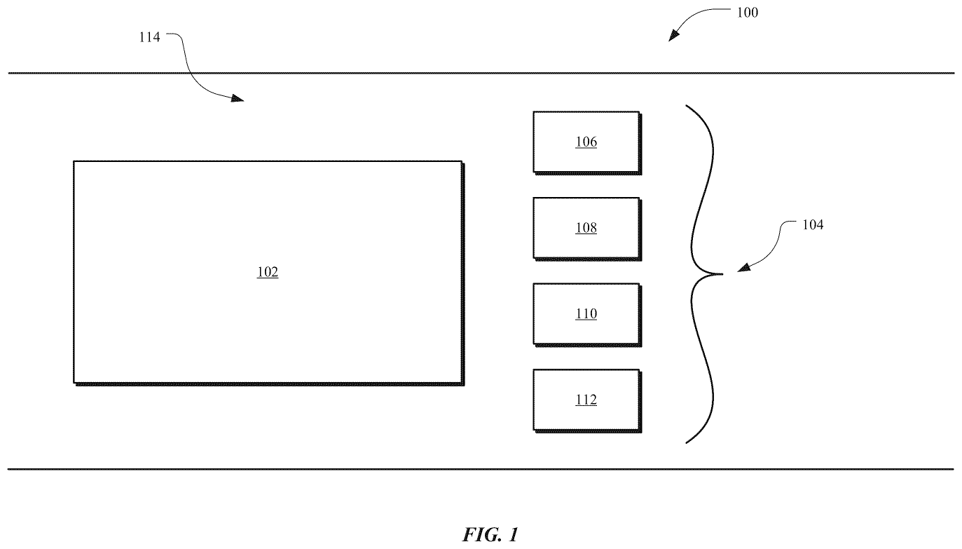

To begin a detailed description of an example environment 100 for shared electronic device operation, reference is made to FIG. 1. Operation of an electronic device 102 may be shared by a plurality of users. Such shared operation may take various forms. For example, each of the plurality of users may have access to control operation of the electronic device 102 during respective operation sessions (e.g., taking turns operating the electronic device 102). During an operation session, one user may control certain operations of the electronic device 102, while other user(s) are present during the operation session but has limited control over operations of the electronic device 102. In another example, the shared operation includes one user monitoring the operation of the electronic device by another user. Such monitoring by the user may additionally take various forms according to user preferences, such as monitoring the other user during the operation of the electronic device 102, providing access to the electronic device 102 for operation by the other user, and/or being a designated contact by the other user in connection with different operational issues. In another example, the electronic device 102 may be part of a group of devices available for operation by the plurality of users. The shared operation of the electronic device 102 may further include the plurality of users having various levels of responsibility for maintaining the electronic device 102 and/or responding to different operational issues of the electronic device 102 in various examples.

A plurality of user devices 104 may be associated with the plurality of users and/or other authorized parties. In some implementations, each user device 104 includes a presentation system, an input system, and a controller. The user devices 104 may be a workstation, smartphone, tablet, wearable, personal computer, and/or other computing devices. The input system may include one or more input devices configured to capture various forms of user input. For example, each of the user devices 104 may be configured to capture visual input (e.g., information provided via gesture), audio input (e.g., information provided via voice), tactile input (e.g., information provided via touch, such as via a touch-sensitive display screen (“touchscreen”), etc.), device input (e.g., information provided via one or more input devices), and/or the like from a user. Similarly, the presentation system of each of the user devices 104 may include one or more output devices configured to present output data in various forms, including visual (e.g., via display, projection, etc.), audio, and/or tactile. The user devices 104 may include various software and/or hardware for input and presentation. The input system and the presentation system may be integrated into one system, in whole or part, or separate. For example, one aspect of the input system and the presentation system may be provided in the form of a touchscreen.

In one example, the plurality of users includes a first user, a second user, and a third user. The first user and the second user may each have access to operate the electronic device 102, and the third user may have access to operate the electronic device 102, as well as monitor the operation of the first user and the second user. The user devices 104 may include a first user device 106, a second user device 108, a third user device 110, and a fourth user device 112. In one example, the first user device 106 and the second user device 108 may be associated with the first user; the third user device 110 may be associated with the second user; and the fourth user device 112 may be associated with the third user. Each of the user devices 104 may be in communication with the electronic device 102. In various instances, the user devices 104 may be in a proximity of the electronic device 102, in an interior of the electronic device 102, exterior to the electronic device 102, and/or remote from the electronic device 102. The user devices 104 may be configured to communicate with the electronic device 102 over a wireless connection and/or wired connection. According to user preferences and authorization, the electronic device 102 may be configured to communicate with one or more of the user devices 104 through a paired connection and/or detect a presence of the user devices 104 in a proximity and/or interior of the electronic device 102.

In addition to communication with the user devices 104, the electronic device 102 may be configured to execute one or more operations, which may include without limitation, movement operations (e.g., movement of the electronic device 102 and/or accessories, components, subsystems, etc. of the electronic device 102), planning operations, entertainment operations, communication operations, access operations, lighting operations, personalization operations, security operations, accessory operations, and/or other operations by the electronic device 102 and associated systems and devices. One or more of these operations may cause the electronic device 102 to move along a movement path 114. The shared operation may include the plurality of users having access to direct at least a portion of the operations of the electronic device 102 via instructions. An operation session may generally correspond to a duration of use of the electronic device 102 (e.g., a trip from an origin towards a destination along the movement path 114) during which one or more operations are executed at least in part based on instructions given by one or more users.

In one example, the first user and the second user may each have access to provide navigation input for directing the electronic device 102 along the movement path 114 during respective operation sessions. In various circumstances, the electronic device 102 may adapt or disregard the navigation input based on sensor data, motion planning, and/or other planning by the electronic device 102. In some examples, the first user and the second user may each be in an interior of the electronic device 102 as it moves along the movement path 114. In such examples, while the operation sessions of the first user and the second user may be occurring concurrently, a type of operation session for the first user is different than for the second user. More particularly, the first user may have access to the electronic device 102 in a driver type operation session, including access to direct the movement of the electronic device 102 along the movement path, while the second user has access to the electronic device 102 in a passenger type operation session that limits access to directing the movement of the electronic device 102 but permits access to controlling other operations of the electronic device 102. In some examples, the operation sessions of the first user and the second user occur at different times, such that the first user directs operations of the electronic device 102 (including the movement along the movement path 114) during a first operation session, and the second user directs operations of the electronic device 102 (including the movement along the movement path 114) during a second operation session.

The third user may have access to monitor the operation of the first user and the second user in the shared operation of the electronic device 102. According to user authorization and preferences, the third user may monitor the first user and the second user in various manners. For example, the third user may be permitted to monitor the operation sessions of the first user, including location, movement (e.g., speed), occupancy, device usage, and/or operations performed during the operation session. Meanwhile, the third user may not monitor the operation sessions of the second user but may be a designated contact by the second user.

More particularly, various operational issues may arise in connection with operation of the electronic device 102. Operational issues may include, without limitation, a condition of the electronic device 102 that may affect operation of the electronic device 102; a status of the electronic device 102; a location of the electronic device 102 in connection with an operation session; a time associated with an operation session; and/or a condition of a user in connection with an operation session. Depending on the nature of a particular operational issue, specific users may be better suited or otherwise be preferred to be notified about the operational issue. Accordingly, rather than having a one-to-one relationship of the electronic device 102 with all users in a shared operation ubiquitously receiving all operation alerts, particular users and/or particular user devices are identified and alerted for specific operational issues associated with the electronic device 102.

The operation alerts, the user devices 104, the users, and the operational issues may be customized within the shared operation of the electronic device 102 according to user preferences and authorization. In one example, the shared operation may be configured such that if the second user is operating the electronic device 102 and a supplemental restraint system is deployed during the operation session, the third user is alerted via the fourth user device 112. In another example, if the first user is operating the electronic device 102 and the electronic device 102 travels within or outside of a designated area during an operation session, the third user is alerted via the fourth user device 112. The first user may also receive the operation alert via the first device 106, the second device 108, and/or the electronic device 102. Similarly, in another example, if the first user is operating the electronic device 102 during an operation session past a time threshold, the third user may be alerted via the fourth device 102. The first user may also receive the operation alert via the first device 106, the second device 108, and/or the electronic device 102.

In another example, if the electronic device 102 is in a particular condition (e.g., turned off, unattended, and unlocked), an operation alert is routed to appropriate user(s) and/or user device(s). The first user may have most recently operated the electronic device 102 during an operation session, and the second user may be at or traveling to a location closer to a current location of the electronic device 102 than a location of the first user. In this scenario, the operation alert may be configured to identify the user(s) to alert and the user device(s) to which the operation alert should be routed. According to user preferences, the first user may be identified based on the most recent operation, and the first user device 106 may be identified based on a recent pairing with the electronic device 102, a recent detection of the first user device 106, based on a user profile of the first user, and/or other user preferences. The operation alert is routed to the first user device 106 accordingly. In some examples, the second user device 108 may also receive the operation alert. The second user device 108 may receive the operation alert: if a response from the first user device 106 is not received; concurrent with the operation alert being routed to the first user device 106; and/or otherwise according to user preferences. The second user may alternatively or additionally be identified for receiving the operation alert based on the location proximity and/or otherwise according to user preferences. For example, the second user may subscribe to any operation alerts involving the electronic device 102 being in the particular condition and/or when the first user is unresponsive after a period of time. The third user device 110 may be identified for routing the operation alert to the second user. The third user may similarly subscribe to receiving the operation alert under various conditions according to user preferences. For example, the third user may receive any operation alerts sent to the first user. In other examples, the third user may receive operation alerts when the first user and/or the second user is unresponsive, depending on the nature of the particular condition of the electronic device 102, etc. The fourth user device 112 may be identified for receiving the operation alert.

In some examples, the shared operation may be configured to route operation alerts to users in addition or alternative to the most recent user and/or the user located closest to a current location of the electronic device 102. For example, the operational issue may include a maintenance issue. The third user may own the electronic device 102 and be responsible for general maintenance of the electronic device 102. Accordingly, while the first user may have most recently operated the electronic device 102 during an operation session and the second user is closest to the electronic device 102, the third user may receive the operation alert corresponding to a battery change for the electronic device 102 via the fourth user device 112. In another example, the first user may operate the electronic device 102 during an operation session in which the first user provided instructions to the electronic device 102 that caused a component to break. The second user may then operate the electronic device 102 during a subsequent operation session. The first user may be correlated with the instruction that caused the component to break and/or the operation session during which the component broke, with the corresponding operation alert being routed to the first user via the first user device 106 and/or the second user device 108. The third user may subscribe to receive all operation alerts for the electronic device 102 and/or particular operation alerts and also receive the operation alert via the fourth user device 112.

Additionally or alternatively, the electronic device 102 may be used in different manners depending on a particular user's preferences. In some examples, a shared operation configuration for the plurality of users of the electronic device 102 is obtained, and the device trigger in the form of a preference trigger corresponding to preferred operation of the electronic device 102 by a particular user is detected. The electronic device 102 implements a set of preferences of the particular user for operation based on the shared operation configuration and in response to the preference trigger. The preference trigger may be detected based on login by the particular user with an identifier, pairing of a user device corresponding to the particular user, detection of the user device corresponding to the particular user within, entering, and/or exiting a vicinity of the electronic device 102 and/or a geofence, identification of the particular user (e.g., using biometrics), user input, and/or so forth. Accordingly, the electronic device 102 may be shared by a plurality of users while providing a customized experience tailored to preferences of each user during an operation session by that user. Operation of the electronic device 102 may be dynamically configured based on the particular user operating the electronic device 102 during an operation session and alerts may be routed to the particular user based on the preferences of that particular user as defined in the shared operation configuration (e.g., one user may specify certain alerts to receive when in a vicinity of the electronic device 102 but not when outside the vicinity).

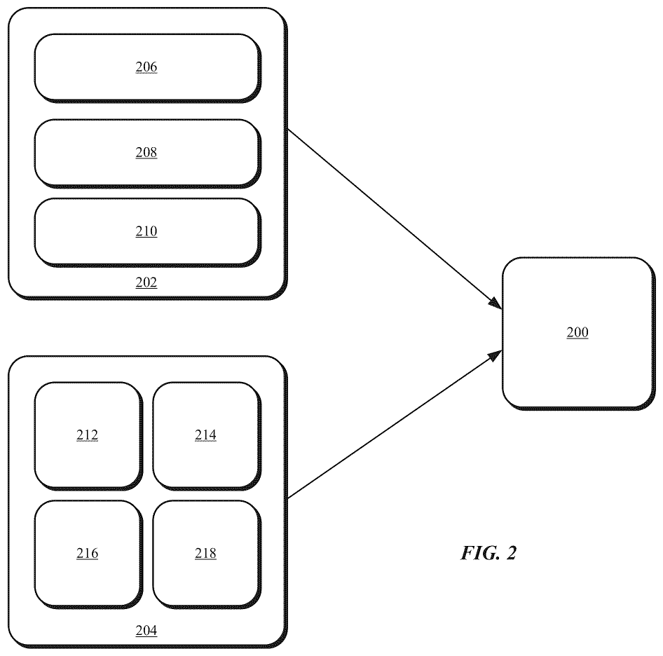

It will be appreciated that each of these examples is exemplary only and that particular user(s) and/or user device(s) may be identified for routing operation alerts in connection with shared operation of the electronic device 102 appropriately according to user preferences. The identification and routing may be configured and customized in various manners by the users involved in the shared operation. For example, referring to FIG. 2, an operation alert 200 may be generated based on a shared operation configuration 202 for shared operation of the electronic device 102 by the users and detection of a device trigger 204 corresponding to an operational issue of the electronic device 102.

In some implementations, the shared operation configuration 202 is generated based on operation session parameters 206, trigger parameters 208, alert parameters 210, and/or other electronic device operation data. The shared operation configuration 202 may be customized and updated in various manners according to user preferences.

The operation session parameters 206 may link operation of the electronic device with one or more of the plurality of users and/or the user devices 104. For example, the operation session parameters may include use parameters, device pairing parameters, device detection parameters, and/or user detection parameters. The use parameters may specify most recent operation session, operation session correlated with an occurrence of the device trigger 204, an instruction that caused an occurrence of the device trigger 204, a type of operation session (e.g., passenger, driver, etc.), and/or other parameters corresponding to identification of particular user(s) based on use of the electronic device 102. The device pairing parameters and the device detection parameters may similarly be used to identify particular user(s) and/or particular user device(s) from the user devices 104. The device pairing parameters may include most recent paired device, device paired during occurrence of the device trigger 204, and/or device paired during an instruction that caused occurrence of the device trigger 204. Similarly, the device detection parameters may include most recently detected device, device detected during occurrence of the device trigger 204, device detected during an instruction that caused the occurrence of the device trigger 204, device that sent the instruction that caused the occurrence of the device trigger 204, device detected in closest proximity to the electronic device 102, device detected in an interior of the electronic device 102, position of the device within the interior when detected, etc. The user detection parameters may specify user(s) most recently present in a vicinity of the electronic device 102, user operating the electronic device 102 most recently, user operating the electronic device 102 during the occurrence of the device trigger 204, user providing the instruction that caused the occurrence of the device trigger 204, position of the user within the interior of the electronic device 102, and/or other user identification.

In connection with data corresponding to detection of the device trigger 204, a particular user and/or user device 104 may be identified according to configuration of the operation session parameters 206. For example, the device trigger 204 may be correlated with a particular operation session and/or instruction by the first user, but the second user may be the most recent user operating the electronic device 102 as a driver with the third user present as a passenger. Based on the operation session parameters 206, the operation alert 200 may be routed to the first user, the second user, and/or the third user via one or more of the user devices 104. Other examples will be readily apparent.

The trigger parameters 208 may link the device trigger 204 with one or more of the users and/or the user devices 104. For example, the trigger parameters 208 may correlate one or more of the users and/or the user devices 104 with time parameters, location parameters, and/or trigger type parameters. The time parameters may specify particular times, time windows, schedules, times of day, times of week, times of month, times of year, seasons, predefined times, customized times, and/or recurring times. The location parameters may specify geographical areas, boundaries, cities, states, counties, countries, predefined areas, customized areas, addresses, coordinates, points of interest, and/or locational references. The trigger type may include device status, object status, and/or environment status. The device status may specify various conditions, states, and other operational issues of the electronic device 102. For example, the conditions may include maintenance issues, diagnostic issues, and/or other conditions affecting operation of the electronic device 102. The states may include locked, unlocked, open, closed, on, off, idling, parked, moving, armed, and/or the like. The object status may correspond to objects connected to, mounted to, and/or otherwise associated with the electronic device 102, such as accessories. The object status may similarly specify various conditions, states, and other operational issues of the objects associated with the electronic device 102. The environmental status may correspond to a physical environment in which the electronic device 102 operates and/or is located. The environmental status may include weather conditions, lighting conditions, objects (e.g., stationary or moving objects) located external to the electronic device 102 and/or along the movement path 114, road surface conditions, etc.

In connection with data corresponding to detection of the device trigger 204, a particular user and/or particular device(s) of the user devices 104 may be identified according to configuration of the trigger parameters 208. For example, the trigger parameters 208 may specify that the first user is only to receive the operation alert 200 using the first device 106 during certain time windows and receive the operation alert 200 using the second device 108 during other time windows. In another example, the trigger parameters 208 may specify that the second user only receive the operational alert 200 when the electronic device 102 or the second user are located within certain geographical areas. In another example, the trigger parameters 208 may specify that the third user receives the operation alert 200 when the device trigger 204 corresponds to a specific device condition of the electronic device 102. Again, other examples will be readily apparent.

The alert parameters 210 link the operation alert 200 with one or more of the plurality of users and/or one or more of the user devices 104. For example, the alert parameters may include user parameters, device parameters, monitoring parameters, and/or priority parameters. The user parameters may specify which of the users to which to route the operation alert 200, and the device parameters may specify which of the user devices 104 to which to route the operation alert 200. In this manner, the user parameters may provide a subscription of users to specific operation alerts, and the device parameters may provide a subscription of devices to specific operation alerts. The monitoring parameters may associate a particular user with another user for receiving operation alerts. For example, the third user may receive all or specific operation alerts that are being sent to the first user and may receive specific operation alerts as a designated contact for the second user. The priority parameters may include priority levels for when to escalate the operation alert 200 (e.g., by sending to another user, sending to another of the user devices 104, sending to an authorized third party, etc.). The priority parameters may specify an order, a hierarchy, and/or different combinations for when and how to escalate operation alerts. The alert parameters 210 may be captured in user profile(s) associated with the user(s) of the shared operation of the electronic device 102. The alert parameters 210 may further specify the form of the operation alert 200 (e.g., call, text, email, application notification, push notification, etc.).

Based on various combinations of the operation session parameters 206, the trigger parameters 208, the alert parameters 210, and/or other electronic device operation data, the shared operation configuration 202 may be customized to specify when, how, and to whom the operation alert 200 representing the device trigger 204 should be sent. Accordingly, in connection with the device trigger 204 being detected, the device trigger 204 may be analyzed based on the shared operation configuration 202 to generate and send the operation alert 200.

More particularly, the device trigger 204 may correspond to an operation issue for the electronic device 102. For example, the device trigger 204 may include a device condition trigger, a location trigger, a time trigger, and/or a user trigger. The device condition trigger may correspond to: a condition and/or status of systems, components, accessories, and/or operations of the electronic device 102; a condition of an environment in which the electronic device 102 is located; and/or a condition of resources associated with the operation of the electronic device 102. The location trigger may correspond to detection of the electronic device 102 at, within, approaching, leaving, away from, and/or outside of one or more locations. The time trigger may correspond to the electronic device 102 being operated and/or not operated at one or more times. The user trigger may correspond to a condition of one or more users (e.g., user(s) of the shared operation of the electronic device 102, occupants, unknown persons, etc.). The device trigger 204 may be detected based on the shared operation configuration 202, and the operation alert 200 representing the device trigger 204 may be generated and communicated to particular user(s) and/or particular user device(s) 104 accordingly. In some instances, a status of the device trigger 204 may be determined (e.g., following a time period since the operation alert 200 was sent). If the device trigger 204 has not been acknowledged, and/or resolved, a reminder alert representing a current status of the device trigger 204 may be generated and sent according to the shared operation configuration 202.

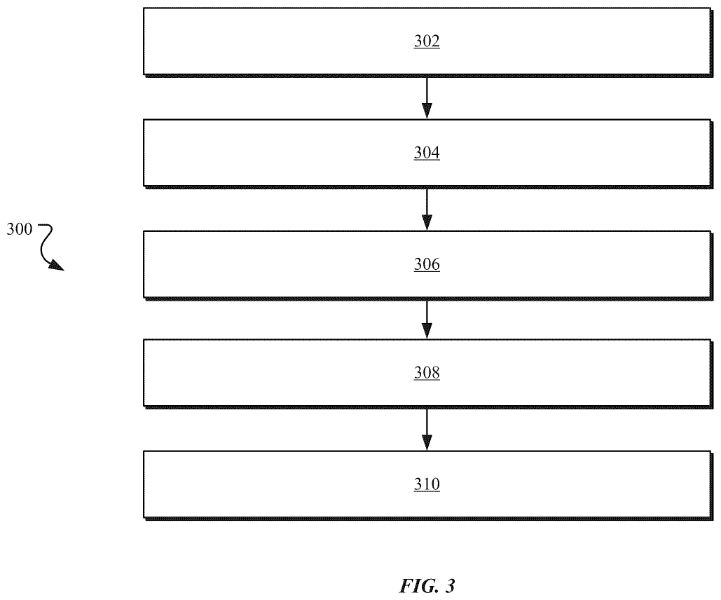

Turning to FIG. 3, example operations 300 for generating a shared operation configuration are illustrated. In some implementations, an operation 302 identifies a plurality of users having a shared operation of an electronic device. The shared operation may include each of the plurality of users having access to control operation of the electronic device during respective operation sessions. The shared operation may further include the plurality of users having various levels of responsibility for maintaining the electronic device and responding to different operational issues of the electronic device. In some examples, the shared operation includes a first user of the plurality of users monitoring the operation of the electronic device by a second user according to user preferences.

The shared operation may be configured and customized in various manners to notify one or more of the plurality of users of operational issues corresponding to an operation of the electronic device, such that the operational issues are timely communicated for response by the appropriate user(s). For example, an operation 304 may obtain a set of one or more operation session parameters, an operation 306 may obtain a set of one or more trigger parameters, and/or an operation 308 may obtain a set of one or more alert parameters. The operation session parameter(s) may be configured to link operation of the electronic device with one or more of the plurality of users. The trigger parameter(s) may be configured to link a device trigger with one or more of the plurality of users. The alert parameter(s) may be configured to link operation alerts with one or more of the plurality of users and/or one or more user devices.

An operation 310 generates a shared operation configuration for the shared operation of the electronic device. For example, the operation 310 may generate the shared operation configuration based on the set of one or more operation session parameters, the set of one or more trigger parameters, the set of one or more alert parameters, and/or other electronic device operation data according to user preferences. The shared operation configuration may be customized and updated based on user input from one or more of the plurality of users.

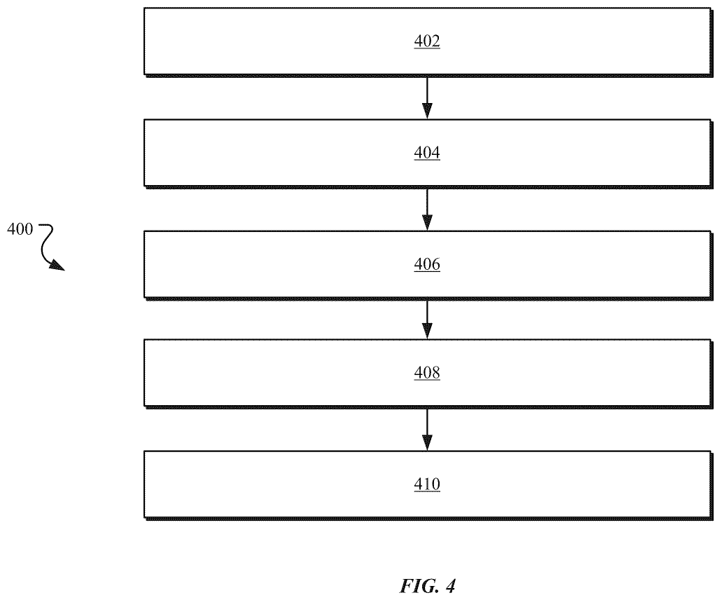

FIG. 4 illustrates example operations 400 for shared electronic device operation. In some implementations, an operation 402 obtains a shared operation configuration for a plurality of users of an electronic device. The shared operation configuration may be customized and updated in various manners according to user preferences. For example, the shared operation configuration may be generated based on one or more operation session parameters, trigger parameters, alert parameters, and or other electronic device operation data.

The operation session parameters link operation of the electronic device with one or more of the plurality of users. For example, the operation session parameters may include use parameters, device pairing parameters, device detection parameters, and/or user detection parameters.

The trigger parameters link a device trigger with one or more of the plurality of users. For example, the trigger parameters may include time parameters, location parameters, and/or trigger type parameters. The trigger type may include device status, object status, and/or environment status in some examples.

The alert parameters link operation alerts with one or more of the plurality of users and/or one or more user devices. For example, the alert parameters may include user parameters, device parameters, monitoring parameters, and/or priority parameters.

In some implementations, an operation 404 detects a device trigger corresponding to operation of the electronic device. The device trigger may include, for example, a device condition trigger, a location trigger, a time trigger, and/or a user trigger.

An operation 406 identifies a particular user amongst the plurality of users based on the shared operation configuration. For example, the particular user may be identified based on a correlation of the device trigger with an operation session of the electronic device by the particular user. In another example, the particular user is identified based on a recent pairing of the user device with the electronic device.

An operation 408 identifies a user device associated with the particular user. The user device may be determined based on a shared operation configuration. In some examples, the user device is one of a plurality of user devices associated with the particular user, and the user device identified from the plurality of user devices for receiving the operation alert. The user device may be identified based on a user profile of the particular user.

An operation 410 generates an operation alert representing the device trigger. The operation 410 may further cause the operation alert to be sent to the user device. For example, the operation alert may be output to a plurality of subscribed devices corresponding to the device trigger, with the user device being one of the plurality of subscribed devices. The operation alert may be provided to the user device associated with the particular user via a call, text, and/or application notification. In some examples, a status of the device trigger may be determined, and a reminder alert may be sent to the user device based on the status of the device trigger.

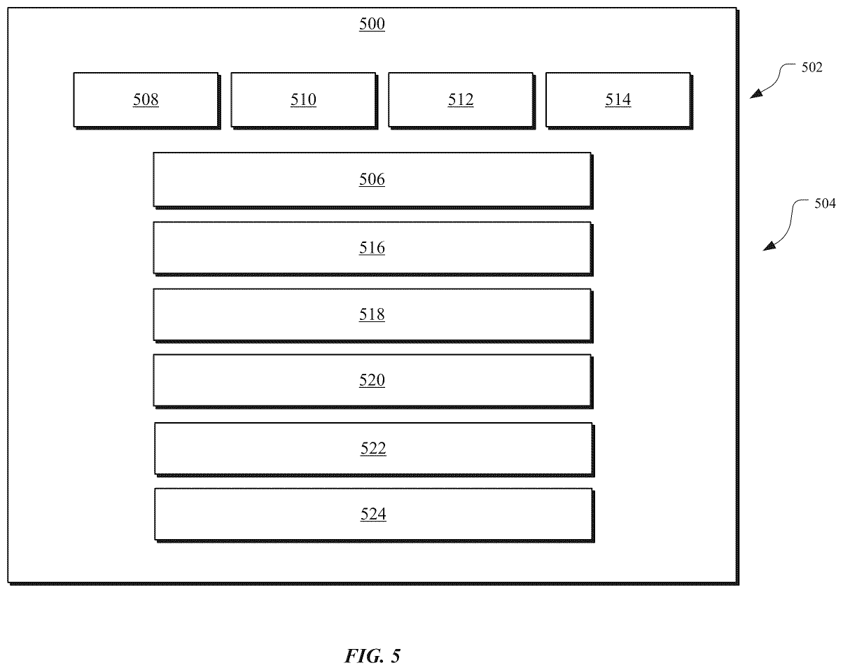

Turning to FIG. 5, an example electronic device 500, which may be the electronic device 102, is shown. In some implementations, the electronic device 500 includes one or more sensor system 502 and device system 504. It will be appreciated that any of a perception system 506, LIDAR sensors 508, cameras 510, localization systems 512, other sensors 514, a planning system 516, a control system 518, subsystems 520, an interface system 522, and/or a communication system 524 may be part of or separate from the sensor system 502 and/or the device system 504.

The sensor system 502 includes one or more sensors configured to capture sensor data, including, but not limited to: data of a field of view of an interior and/or an exterior of the electronic device 500 (e.g., one or more images); localization data corresponding to a location, heading, and/or orientation of the electronic device 500; movement data corresponding to motion of the electronic device 500 (e.g., along the movement path 104); electronic device data, electronic device operation data, environment data, device trigger data, and/or user data (according to user preferences). The one or more sensors of the sensor system 502 may include, without limitation, three-dimensional (3D) sensors configured to capture 3D images, four-dimensional (4D) sensors configured to capture 4D images, RADAR sensors, infrared (IR) sensors, optical sensors, and/or visual detection and ranging (ViDAR) sensors. For example, the one or more 3D sensors may include the LIDAR sensors 508 (e.g., scanning LIDAR sensors) or other depth sensors, and the one or more 4D sensors may include the cameras 510 (e.g., RGB cameras). The cameras 510 may capture color images, grayscale images, and/or other 4D images. The localization systems 512 may capture the localization data. The localization systems may include, without limitation, GNSS, inertial navigation system (INS), inertial measurement unit (IMU), global positioning system (GPS), altitude and heading reference system (AHRS), compass, and/or accelerometer. The other sensors 514 may be used to capture localization data, movement data, electronic device operation data, object data, environment data, user data, device trigger data, and/or other authorized and relevant sensor data.

The perception system 504 can generate perception data, which may detect, identify, classify, and/or determine position(s) of one or more objects and/or detect device triggers using the sensor data. The perception data may be used by a planning system 516 in generating one or more actions for the electronic device 500, such as generating a navigation plan having at least one movement action for autonomously navigating the electronic device 500 along the movement path 104 from an origin towards a destination and/or adjusting operation of one or more of the device systems 506. The control system 518 may be used to control various operations of the electronic device 500, including, but not limited to, generating, customizing, updating, and/or obtaining shared operation configuration; detecting device triggers; generating operation alerts; executing navigation plans, and/or other operations. The navigation plan may include various operational instructions for the subsystems 520 of the electronic device 500 to autonomously execute to perform the navigation action(s), as well as other action(s), such that the electronic device 500 moves on its own planning and decisions. Instructions for operating the electronic device 500 in view of a movement path may be executed by the planning system 516, the control system 518, the subsystems 520, and/or other components of the electronic device 500. The instructions may be modified prior to execution by the electronic device 500 (e.g., using the interface system 522), and in some cases, the electronic device 500 may disregard the instructions, for example, based on the sensor data captured by the sensor system 502.

In some implementations, the interface system 522 includes a presentation system and an input system. The input system of the interface system 522 may include one or more input devices configured to capture various forms of user input. For example, the interface system 522 may be configured to capture data from various sources and/or user input from a user. Similarly, the presentation system of the interface system 522 may include one or more output devices configured to present content, such as operation alerts and shared operation configurations, in various forms, including visual, audio, and/or tactile content in two-dimensions and/or three-dimensions. The interface system 522 may include various software and/or hardware for input and presentation. The input system and the presentation system may be integrated into one system, in whole or part, or separate. For example, the input system and the presentation system of the interface system 522 may be provided in the form of a touchscreen.

In some implementations, the interface system 522 provides an interactive interface. The interactive interface may be deployed in the electronic device 500. For example, the interactive interface may be deployed in an interior of the electronic device 500. The communication system 524 may include, without limitation, one or more antennae, receivers, transponders, transceivers, and/or communication ports for communicating the operation alerts and/or receiving relevant electronic device operation data for generating the operation alerts. In some cases, the communication system 524 is configured to communicate via different types of wireless networks. In some examples, the communication system 524 is configured for long-range communication (e.g., via cellular network, satellite network, radio, etc.), short-range communication (e.g., Bluetooth, Wi-Fi, UWB, etc.), and/or to otherwise communicate with other devices and data sources.

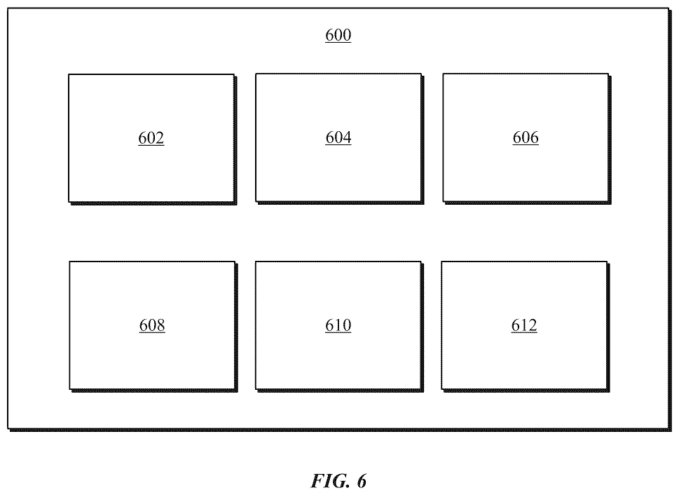

Referring to FIG. 6, a detailed description of an example computing device 600 having one or more computing units that may implement various systems and methods discussed herein is provided. Various components of the computing device 600 can be formed into a specific, non-conventional, and non-generic arrangement to achieve the various technological solutions discussed herein. As such, the computing device 600 and/or components of the computing device 600 may be applicable to the electronic device 102, the user devices 106, various systems and subsystems of the electronic device 500, and other computing or network devices. In some examples, the electronic device 102 and/or the electronic device 500 may be a mobile device, speaker, security system, camera, robot, charging station, vehicle, maintenance system, smartphone, wearable, laptop, tablet, home system, home hub, content system, asset tracking tag, television system, audio-based text to speech devices, and/or other computing systems. It will be appreciated that specific implementations of these devices may be of differing possible specific computing architectures not all of which are specifically discussed herein but will be understood by those of ordinary skill in the art.

The computing device 600 may be a computing system capable of executing a computer program product to execute a computer process. Data and program files may be input to the computing device 600, which reads the files and executes the programs therein. Some of the elements of the computing device 600 are shown in FIG. 6, including one or more hardware processor(s) 602, one or more data storage device(s) 604, one or more memory device(s) 606, and/or one or more port(s) 608-612. Additionally, other elements that will be recognized by those skilled in the art may be included in the computing device 600 but are not explicitly depicted in FIG. 6 or discussed further herein. Various elements of the computing device 600 may communicate with one another by way of one or more communication buses, point-to-point communication paths, or other communication means not explicitly depicted in FIG. 6.

The processor 602 may include, for example, a central processing unit (CPU), a microprocessor, a microcontroller, a digital signal processor (DSP), and/or one or more internal levels of cache. There may be one or more processors 602, such that the processor 602 comprises a single central-processing unit, or a plurality of processing units capable of executing instructions and performing operations in parallel with each other, commonly referred to as a parallel processing environment.

The computing device 600 may be a conventional computer, a distributed computer, or any other type of computer, such as one or more external computers made available via a cloud computing architecture. The presently described technology is optionally implemented in software stored on the data stored device(s) 604, stored on the memory device(s) 606, and/or communicated via one or more of the ports 608-612, thereby transforming the computing device 600 in FIG. 6 to a special purpose machine for implementing the operations described herein. Examples of the computing device 600 include personal computers, servers, purpose-built autonomy processors, terminals, workstations, mobile phones, tablets, laptops, so forth.

The one or more data storage devices 604 may include any non-volatile data storage device capable of storing data generated or employed within the computing device 600, such as computer executable instructions for performing a computer process, which may include instructions of both application programs and an operating system (OS) that manages the various components of the computing device 600. The data storage devices 604 may include, without limitation, magnetic disk drives, optical disk drives, solid state drives (SSDs), flash drives, so forth. The data storage devices 604 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and so forth. Examples of non-removable data storage media include internal magnetic hard disks, SSDs, and so forth. The one or more memory devices 606 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 604 and/or the memory devices 606, which may be referred to as machine-readable media. It will be appreciated that machine-readable media may include any tangible non-transitory medium capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 600 includes one or more port(s), such as an input/output (I/O) port(s) 608, communication port(s) 610, and sub-systems port(s) 612, for communicating with other computing, network, or devices. It will be appreciated that the ports 608-612 may be combined or separate and that more or fewer ports may be included in the computing device 600.

The I/O port 608 may be connected to an I/O device, or other device, by which information is input to or output from the computing device 600. Such I/O devices may include, without limitation, one or more input devices, output devices, and/or environment transducer devices.

In one implementation, the input devices convert a human-generated signal, such as, human voice, physical movement, physical touch or pressure, so forth, into electrical signals as input data into the computing device 600 via the I/O port 608. Similarly, the output devices may convert electrical signals received from computing device 600 via the I/O port 608 into signals that may be sensed as output by a human, such as sound, light, and/or touch. The input device may be an alphanumeric input device, including alphanumeric and other keys for communicating information and/or command selections to the processor 602 via the I/O port 608. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, so forth. In some implementations, the input device and the output device may be the same device, for example, in the case of a touchscreen.

The environment transducer devices convert one form of energy or signal into another for input into or output from the computing device 600 via the I/O port 608. For example, an electrical signal generated within the computing device 600 may be converted to another type of signal, and/or vice-versa. In one implementation, the environment transducer devices sense characteristics or aspects of an environment local to or remote from the computing device 600. Further, the environment transducer devices may generate signals to impose some effect on the environment either local to or remote from the example computing device 600.

In one implementation, a communication port 610 is connected to a network by way of which the computing device 600 may receive network data useful in executing the methods and systems set out herein as well as transmitting information and network configuration changes determined thereby. Stated differently, the communication port 610 connects the computing device 600 to one or more communication interface devices configured to transmit and/or receive information between the computing device 600 and other devices by way of one or more wired or wireless communication networks or connections. Examples of such networks or connections include, without limitation, Universal Serial Bus (USB), Ethernet, Wi-Fi, Bluetooth, Near Field Communication (NFC), cellular, and so on. One or more such communication interface devices may be utilized via the communication port 610 to communicate one or more other machines, either directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 610 may communicate with an antenna for electromagnetic signal transmission and/or reception. In some examples, an antenna may be employed to receive Global Positioning System (GPS) data to facilitate determination of a location of a device.

The present disclosure recognizes that participation in electronic device alerting and shared electronic device operations may be used to the benefit of users. Entities implementing the present technologies should comply with established privacy policies and/or practices that meet or exceed industry or governmental requirements for maintaining the privacy and security of data being communicated. The present disclosure contemplates that any devices participating in the electronic device alerting and share electronic device operations would provide input interfaces for specifying when, where, and what types of operations are to occur and what data is used, thereby permitting users to customize their intended functionality. Devices participating in these services may also provide indications that operations for electronic device alerting are requested and/or active. Moreover, users should be allowed to opt-in or opt-out of allowing a device to participate in such services, including by switching off camera(s) and muting microphone(s). In addition, particular information that is being communicated can be encrypted, structured, and/or coded to further maintain privacy and security. Third parties can evaluate these implementers to certify their adherence to established privacy policies and practices.

The system set forth in FIG. 6 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. One or more tangible non-transitory computer-readable storage media storing computer-executable instructions for performing a computer process on a computing system, the computer process comprising:
obtaining a shared operation configuration for a plurality of users of an electronic device;
detecting a device trigger corresponding to operation of the electronic device;
identifying a particular user amongst the plurality of users based on the shared operation configuration; and
generating an operation alert representing the device trigger, wherein the operation alert is sent to a user device associated with the particular user.

2. The one or more tangible non-transitory computer-readable storage media of claim 1, wherein identifying the particular user amongst the plurality of users comprises determining that the particular user most recently operated the electronic device amongst the plurality of users.

3. The one or more tangible non-transitory computer-readable storage media of claim 1, wherein identifying the particular user amongst the plurality of users comprises determining that the user device associated with the particular user most recently accessed the electronic device.

4. The one or more tangible non-transitory computer-readable storage media of claim 1, wherein the shared operation configuration is generated based on at least one operation session parameter, the at least one operation session parameter linking the operation of the electronic device with the particular user.

5. The one or more tangible non-transitory computer-readable storage media of claim 1, wherein the shared operation configuration is generated based on at least one trigger parameter, the at least one trigger parameter linking the device trigger with the particular user.

6. The one or more tangible non-transitory computer-readable storage media of claim 5, wherein the at least one trigger parameter includes one or more of a time, a location, and a trigger type.

7. The one or more tangible non-transitory computer-readable storage media of claim 1, wherein the shared operation configuration is generated based on at least one alert parameter corresponding to one or more of the plurality of users.

8. The one or more tangible non-transitory computer-readable storage media of claim 7, wherein the operation alert is sent to the user device based on a correlation of the device trigger with a priority level defined by the at least one alert parameter.

9. The one or more tangible non-transitory computer-readable storage media of claim 7, wherein the at least one alert parameter links the particular user to a designated user of the plurality of users and a notification of the operation alert is sent to a second user device associated with the designated user.

10. A method comprising:
detecting a device trigger corresponding to an electronic device, wherein operation of the electronic device is shared among a plurality of users;
identifying a particular user of the plurality of users, wherein a user device is associated with the particular user;
generating an operation alert based on the device trigger; and
sending the operation alert to the user device.

11. The method of claim 10, wherein the user device is one of a plurality of user devices associated with the particular user, the user device identified from the plurality of user devices for receiving the operation alert.

12. The method of claim 11, wherein the user device is identified based on a user profile of the particular user.

13. The method of claim 10, wherein the particular user is identified based on a correlation of the device trigger with an operation session of the electronic device by the particular user.

14. The method of claim 10, wherein the particular user is identified based on a recent pairing of the user device with the electronic device.

15. The method of claim 10, wherein the particular user is identified based on a recent detection of the user device in an interior of the electronic device.

16. The method of claim 10, further comprising:
determining a status of the device trigger; and
sending a reminder alert to the user device based on the status of the device trigger.

17. A system comprising:
at least one processor configured to generate an operation alert and identify a particular user of a plurality of users, the operation alert generated based on a device trigger corresponding to an electronic device, wherein operation of the electronic device is shared among the plurality of users, wherein the operation alert is provided to a user device associated with the particular user.

18. The system of claim 17, wherein the operation alert is output to a plurality of subscribed devices corresponding to the device trigger, the user device being one of the plurality of subscribed devices.

19. The system of claim 17, wherein the user device is determined based on a shared operation configuration.

20. The system of claim 19, wherein the shared operation configuration is generated based on at least one of an operation session parameter, an trigger parameter, or an alert parameter.

21. The system of claim 17, wherein the device trigger includes at least one of: a device condition trigger, a location trigger, a time trigger, or a user trigger.

22. The system of claim 17, wherein the operation alert is provided to the user device associated with the particular user via at least one of a call, text, or application notification.
